(19) United States
(12) Patent Application Publication
(10) Pub. No.: US 2013/0043849 A1
(43) Pub. Date: Feb. 21, 2013

(54) Voltage Converter Including Variable Mode Switching Regulator And Related Method

(71) Applicant: Rosario Pagano, Fort Collins, CO (US)

(72) Inventor: Rosario Pagano, Fort Collins, CO (US)

(73) Assignee: Broadcom Corporation, Irvine, CA (US)

(21) Appl. No.: 13/212,977

(22) Filed: Aug. 18, 2011

(51) Int. Cl. G05F 1/10

(52) U.S. Cl. 323/271

(57) ABSTRACT

According to one embodiment, a voltage converter comprises a switching regulator, a driver, and a power stage receiving an input voltage and producing a converted output voltage. The switching regulator is configured to utilize a voltage control path and a current control path to provide feedback to the driver corresponding to a load condition of a load in the power stage, allowing the driver to adjust the converted output voltage in response to the feedback. In one embodiment, the switching regulator utilizes the voltage control path and the current control path to transition control of the voltage converter between a fixed frequency mode control, such as a current-programmed mode (CPM) control, and a variable frequency mode control, such as a hysteretic mode control.

### BACKGROUND OF THE INVENTION

1. Field of the Invention

The present invention is generally in the field of electrical circuits and systems. More specifically, the present invention is in the field of power conversion and regulation in electrical circuits and systems.

2. Background Art

Voltage converters are used in a variety of electronic circuits and systems. Many integrated circuit (IC) applications, for instance, require conversion of a direct current (DC) input signal to a lower, or higher, DC output. For example, a voltage converter may be implemented to convert a higher voltage DC input to a lower voltage DC output for use in low voltage applications in which relatively large output currents are required to support heavy load operation.

One conventional approach to implementing a voltage converter includes utilizing a current-programmed mode (CPM) control scheme to regulate the power stage providing the converted voltage output. That approach, which uses fixed frequency switching, typically results in efficient performance and good load and line regulation during heavy load conditions. However, CPM control tends to manifest a less than optimal load step response during transitions between heavy and light load conditions. Moreover, in order to improve operating efficiency during light load conditions, pulse skipping or pulse frequency modulation is typically required, thereby complicating the control scheme during light load operation.

An alternative approach to regulating a voltage converter implements a variable frequency control mode, such as a hysteretic control mode, for example, which is capable of efficient performance during light load conditions. In addition, the load step response of a voltage converter implemented using a hysteretic mode control regulation scheme is advantageously faster than that of the previously described CPM controlled voltage converter. However, load and line regulation is not as good as that achievable using a fixed frequency control mode such as CPM control. Although during light load operation the additional voltage ripple may be more than offset by the increased efficiency resulting from the variable switching frequency control scheme, during heavy load conditions the additional voltage ripple at the output may become problematic, and in some applications may render use of hysteretic mode control impracticable.

Due to the increasing prevalence of devices and systems that are required to operate for extended periods in a light load standby mode, for example, as well as to respond rapidly and stably to power heavy loads when called upon, no longer can any of light load efficiency, heavy load efficiency, or load step responsiveness be compromised. Thus, there is a need to overcome the drawbacks and deficiencies in the conventional art by providing a voltage converter including a variable mode switching regulator configured to be responsive to load step transitions while providing high efficiency across a spectrum of operating conditions including light load conditions and heavy load conditions.

### SUMMARY OF THE INVENTION

The present invention is directed to a voltage converter including a variable mode switching regulator and related method, substantially as shown in and/or described in connection with at least one of the figures, and as set forth more completely in the claims.

### BRIEF DESCRIPTION OF THE DRAWINGS

FIG. 1 shows a diagram of a voltage converter including a variable mode switching regulator, according to one embodiment of the present invention.

FIG. 2A is a graph showing traces corresponding to a load current and inductor current produced by a voltage converter including a variable mode switching regulator, according to one embodiment of the present invention.

FIG. 2B is a graph showing a trace of an error voltage corresponding to a feedback provided by a variable mode switching regulator, according to one embodiment of the present invention.

FIG. 2C is a graph showing a trace of an output voltage and related control mode transitions of a voltage converter including a variable mode switching regulator, according to one embodiment of the present invention.

FIG. 3 is a flowchart of a method for controlling a voltage converter including a variable mode switching regulator, according to one embodiment of the present invention.

### DETAILED DESCRIPTION OF THE INVENTION

The present invention is directed to a voltage converter including a variable mode switching regulator and a related method. Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention, which use the principles of the present invention, are not specifically described in the present application and are not specifically illustrated by the present drawings. It should be borne in mind that, unless noted otherwise, like or corresponding elements among the figures may be indicated by like or corresponding reference numerals. Moreover, the drawings and illustrations in the present application are generally not to scale, and are not intended to correspond to actual relative dimensions.

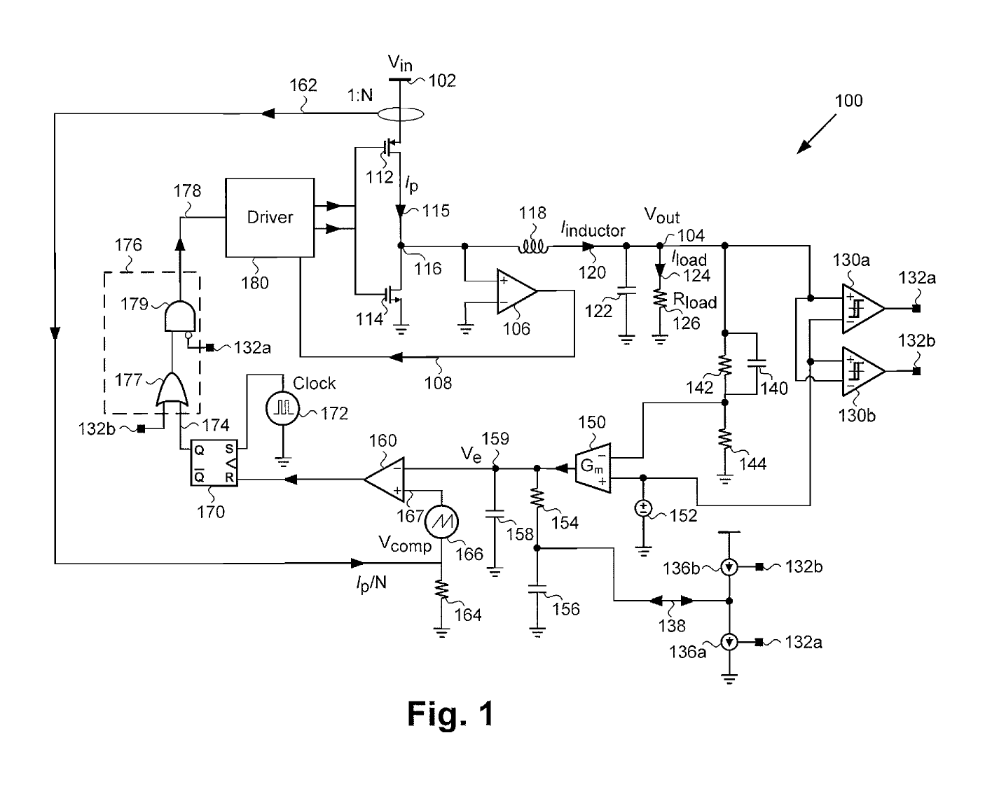

FIG. 1 is a diagram of voltage converter 100 including a variable mode switching regulator, according to one embodiment of the present invention. As shown in FIG. 1, voltage converter 100 comprises driver 180 implemented to drive a power stage including high side switch 112, low side switch 114, switching node 116, output inductor 118, ripple capacitor 122, and load 126. As may be apparent from FIG. 1, the described power stage is configured to receive an input voltage at input 102 and to produce a converted output voltage at node 104. According to the embodiment shown in FIG. 1, driver 180 is used to control the operation of high side switch 112 and low side switch 114 to produce inductor current 120, which, after filtering by ripple capacitor 122, is provided to load 126 as load current 124. Voltage converter 100 may be fabricated as part of an integrated circuit (IC) to provide voltage conversion and regulation for load 126, which may be implement as part of the same monolithic IC, for example.

As discussed above, in conventional implementations, a fixed frequency switching regulation scheme is typically used to control voltage converter output because of the operational efficiency of that approach during heavy load conditions. However, the reduced efficiency of fixed frequency control for light load conditions typically requires use of remedial techniques such as pulse skipping or pulse frequency modulation, which undesirably introduce additional complexity. In addition, fixed frequency switching regulation schemes may not provide a sufficiently rapid response to load steps between heavy load and light load conditions. Moreover, despite being characterized by increased efficiency during light load operation, and by a rapid load step response, variable frequency switching regulation techniques, such as hysteretic mode control, for example, may not provide adequate efficiency, or adequately precise load and line regulation, during heavy load conditions. Consequently, there is a need in the art, unmet by conventional approaches, for achieving efficient, responsive, and precise switching regulation across a wide range of operating conditions, in response to the demands of a stepped load.

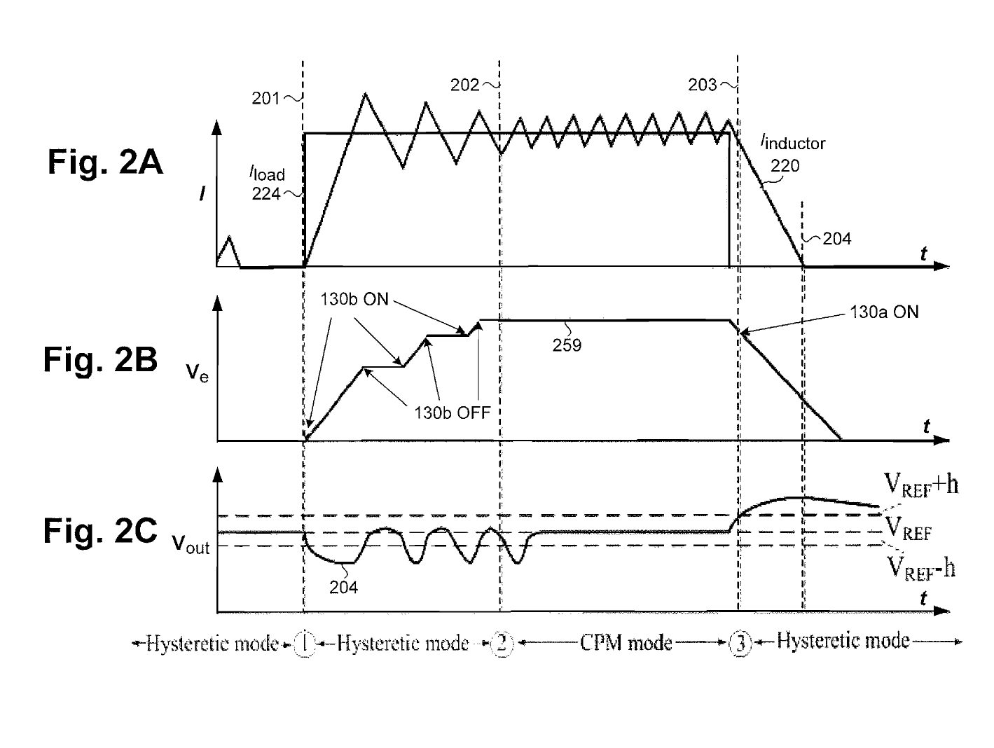

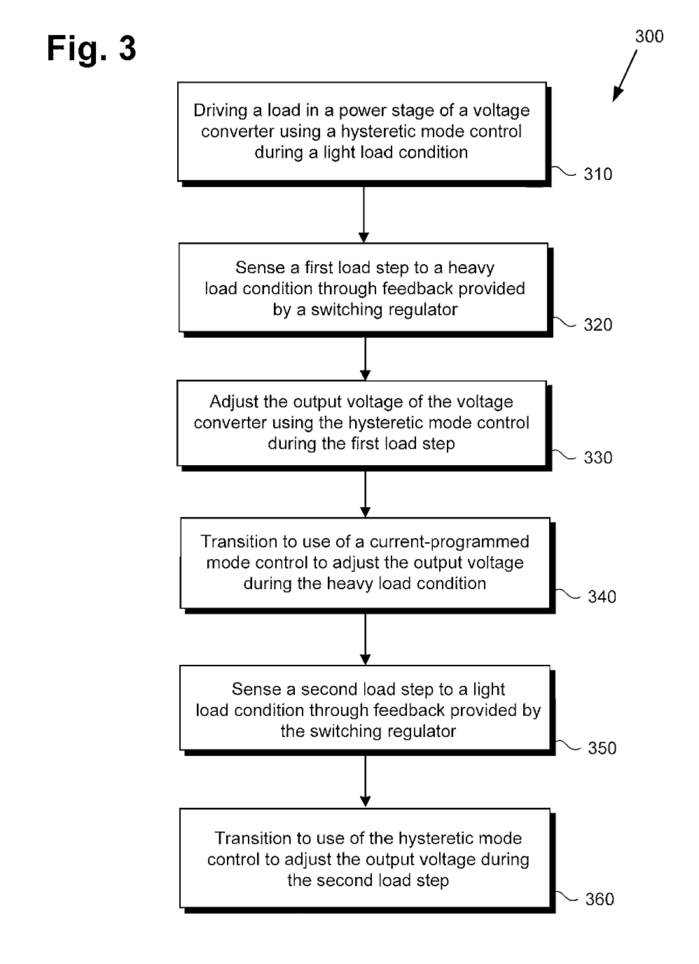

Voltage converter 100, shown in FIG. 1, overcomes the drawbacks and deficiencies of conventional voltage converter circuits by including a variable mode switching regulator configured to utilize a voltage control path and a current control path to provide feedback to driver 180 corresponding to a load condition of load 126. As will be explained more fully by reference to FIGS. 2A, 2B, 2C, and 3, voltage converter 100 is configured to enable driver 180 to adjust the converted output voltage produced at node 104 according to the feedback from the switching regulator. Load 126 may be a stepped load, for example, including operation at a heavy load condition and operation at a light load condition, as well as load step transitions between the light and heavy load conditions.

As mentioned above, and as will be described in greater detail below, the variable mode switching regulator implemented in voltage converter 100 is configured to utilize a voltage control path and a current control path to provide feedback to driver 180. In some embodiments, the switching regulator can utilize the voltage control path and the current control path to transition control of voltage converter 100 between a fixed frequency mode control and a variable frequency mode control.

For example, according to the specific embodiment shown in FIG. 1, a voltage control path of the variable mode switching regulator may be configured to provide hysteretic mode control of driver 180 (e.g., a variable frequency mode control), and may include hysteretic comparators 130a and 130b implemented to provide respective outputs 132a and 132b. As shown in FIG. 1, the outputs 132a and 132b of respective hysteretic comparators 130a and 130b are provided as inputs to logic block 176, which is shown to include OR gate 177 and AND gate 179, and which is configured to provide control signal 178 to driver 180. As further shown in FIG. 1, output 132b of hysteretic comparator 130b is provided as an input to OR gate 177, while output 132a of hysteretic comparator 130a is inverted and provided as an input to AND gate 179, which receives the output of OR gate 177 as a second input.

The current control path of the variable mode switching regulator implemented as part of voltage converter 100 can be configured to provide current-programmed mode (CPM) control over driver 180 (e.g., a fixed frequency mode control), for example. According to one such embodiment, as shown in FIG. 1, the current control path may comprise a voltage divider formed from resistors 142 and 144, feed forward capacitor 140, transconductance amplifier 150, the RC network including resistor 154 and capacitors 156 and 158 producing error voltage Vₑ at error node 159, comparator 160, and SR flip-flop 170 driven by clock 172. The current control path of FIG. 1 further includes current attenuation branch 162 for performing a 1/N attenuation of programmed current 115 flowing through high side switch 112 of the power stage, as well as sense resistor 164 and ramp compensation 166 for producing reference input 167 to comparator 160. As may be seen from FIG. 1, comparator 160 is implemented so as to compare the error voltage produced at error node 159 with reference input 167. The output of comparator 160 is provided as an input to SR flip-flop 170, which, under the control of clock 172, provides output 174 to OR gate 177.

Also shown in FIG. 1 are zero current detector 106 and zero current feedback path 108, current sources 136a and 136b controlled by respective outputs 132a and 132b of hysteretic comparators 130a and 130b, and voltage reference source 152. According to the embodiment of FIG. 1, voltage reference source 152 is shared in common by transconductance amplifier 150 and hysteretic comparators 130a and 130b. Moreover, control over current sources 136a and 136b by respective hysteretic comparators 130a and 130b can facilitate transition between the fixed frequency CPM control, and the variable frequency hysteretic mode control, according to the load condition of load 126, while logic block 176 alternately enables hysteric mode control and CPM control of driver 180.

Thus, the embodiment shown in FIG. 1 enables the switching regulator of voltage converter 100 to utilize the described voltage control path and current control path to advantageously implement CPM control of driver 180 when load 126 is a heavy load, and to implement hysteretic mode control of driver 180 when load 126 is a light load, thereby providing efficient light load and heavy load operation. In addition, the switching regulator of voltage converter 100 can utilize the described voltage control path and current control path to advantageously implement hysteretic mode control, due to its faster step response, when the load condition of load 126 corresponds to a load step between a light load and a heavy load, e.g., from a light load to a heavy load or from a heavy load to a light load.

The operation of voltage converter 100 will be described in greater detail in combination with FIGS. 2A, 2B, 2C, and 3. FIG. 2A is a graph of current versus time showing traces 224 and 220 corresponding respectively to load current 124 and inductor current 120 produced by a voltage converter 100, according to the embodiment of FIG. 1, while FIG. 2B is a graph of voltage versus time showing trace 259 of the error voltage measured at error node 159, according to that embodiment. In addition, FIG. 2C is a graph of voltage versus time showing trace 204 of the output voltage at node 104 and related control mode transitions of voltage converter 100, according to the embodiment of FIG. 1.

Regarding FIG. 3, FIG. 3 shows flowchart 300 of a method for controlling a voltage converter including a variable mode switching regulator, such as voltage converter 100, in FIG. 1, according to one embodiment of the present invention. It is noted that certain details and features have been left out of flowchart 300, in FIG. 3, that are apparent to a person of ordinary skill in the art. For example, a step may comprise one or more substeps or may involve specialized equipment or materials, as known in the art. While steps 310 through 360 indicated in flowchart 300 are sufficient to describe one embodiment of the present invention, other embodiments of the invention may utilize steps different from those shown in flowchart 300, or may comprise more, or fewer, steps.

Referring to step 310 in FIG. 3 and voltage converter 100 in FIG. 1, step 310 of flowchart 300 comprises driving load 126 in the power stage of voltage converter 100 using a variable frequency hysteretic mode control during a light load condition. Step 310 may be performed by driver 180 under the control of logic block 176 of the variable mode switching regulator, and corresponds to the operating conditions shown in FIGS. 2A, 2B, and 2C prior to time 1, indicated by dashed vertical line 201 common to FIGS. 2A, 2B, and 2C.

Continuing with step 320 in FIG. 3, step 320 of flowchart 300 comprises sensing a first load step to a heavy load condition through feedback provided by the switching regulator. As explained previously when discussing FIG. 1, the variable mode switching regulator is configured to utilize a voltage control path and a current control path to provide feedback to driver 180. As shown by FIG. 2A, a load step from a light load condition to a heavy load condition occurs at time 1 and corresponds to an increase in the current provided as inductor current 220 and load current 224. Such a load step may correspond, for example, to a step up from a light load current of less than approximately 100 mA, or less, to a heavy load current of approximately 2 A or more. Referring to FIG. 2C, the load step at time 1 also corresponds to a drop in the output voltage 204. That drop, due to the load step at time 1, causes output voltage 204 to drop below the lower threshold of the hysteresis window set by hysteretic comparator 130b (e.g., Vₒᵤₜ<V_{ref-h}).

The drop in the output voltage at node 104 can be sensed, in step 320, using hysteretic comparator 130b of the voltage control path, which compares the output voltage at node 104 to a reference voltage (e.g., V_{ref} in FIG. 2C) provided by voltage reference source 152, and turns ON to provide output 132b when Vₒᵤₜ falls below the hysteresis window. That output 132b from hysteretic comparator 130b of the voltage control path is fed back to driver 180 as control signal 178 from digital block 176, as shown in FIG. 1.

As a result, and as indicated by step 330 of flowchart 300, the variable mode switching regulator of voltage converter 100 adjusts the output voltage at node 104 using the variable frequency hysteretic mode during the first load step. Step 330 is illustrated by FIGS. 2A, 2B, and 2C. Referring to FIG. 2A during the load step time interval from time 1 to time 2 (e.g., interval between dashed vertical lines 201 and 202), inductor current 220 settles to values close to load current 224 within a few oscillation cycles. During that load step interval, FIGS. 2B and 2C show the results of hysteretic mode activation of hysteresis comparator 130b when output voltage 204 drops below V_{ref-h}. Comparing FIGS. 2B and 2C, it can be seen that hysteretic comparator 130b turns ON and remains ON while output voltage 204 is less than V_{ref-h}. Referring to FIG. 1, in addition to providing output 132b to logic block 176, hysteretic comparator 130b also provides output 132b as a control signal to current source 136b. Consequently, while hysteretic comparator 130b is ON, output 132b activates current source 136b, causing charge to accumulate on capacitors 156 and 158 and thereby causing the error voltage at error node 159 to rise during those periods, as shown by FIG. 2B.

During that same load step interval, the adjustment of the output voltage at node 104 by driver 180 causes hysteretic comparator 130b to turn OFF and remain OFF when the output voltage rises above V_{ref-h}. During those periods, the charge accumulated on capacitors 156 and 158 remains, causing the error voltage at error node 159 to remain substantially constant during periods when both of hysteretic comparators 130a and 130b are OFF during hysteretic mode control of driver 180.

Continuing with step 340 of flowchart 300, step 340 comprises transitioning to a fixed frequency CPM control to adjust the output voltage during the heavy load condition. Step 340 corresponds to the time interval between times 2 and 3 in FIGS. 2A, 2B, and 2C (e.g., the interval between vertical dashed lines 202 and 203). During heavy load operation, a fixed frequency mode control, such as CPM control, provides good operating efficiency as well as desirable load and line regulation. According to the embodiment of FIG. 1, the transition from variable frequency hysteretic mode control to fixed frequency CPM control is performed automatically by the variable mode switching regulator of voltage converter 100, using the described voltage control path and current control path.

For example, as the error voltage at error node 159 is slowly increased between times 1 and 2, the pulse width of output 174 from SR flip-flop 170 is also slowly increased. As long as the pulse width of output 174 remains narrower than that provided by output 132b of hysteretic comparator 130b, hysteretic comparator output 132b will determine the performance of logic block 176, and thereby effectively control driver 180.

As a specific example, when hysteretic comparator 130b is ON, hysteretic comparator 130a is OFF, as shown by the arrangement in FIG. 1. As a result, when the pulse width of output 132b is greater than that of output 174 provided by SR flip-flop 170, output 132b will control the behavior of OR gate 177, and the combination of outputs 132a and 132b will control the behavior of AND gate 179, thus determining control output 178. However, when the error voltage at error node 159 becomes sufficiently high, the pulse width of output 174 from SR flip-flop 170 will come to exceed that of output 132b. That transition in pulse width dominance corresponds to the transition from variable frequency hysteretic mode control to fixed frequency CPM control in voltage converter 100, as indicated by FIGS. 2B and 2C.

Once the transition to CPM control has occurred, control output 178 is determined by the current control path components. For example, the voltage divider formed by resistors 142 and 144, feed forward capacitor 140, transconductance amplifier 150, and the RC network of resistor 154 and capacitors 156 and 158 can be used to provide feedback in the form of error voltage Vₑ at error node 159, while current attenuation branch 162, sense resistor 164, and ramp compensation 166 can be used to produce reference input 167. Comparison of Ve and reference input 167 by comparator 160 results in generation of output 174 from SR flip-flop 170, which, as explained above, is the dominant signal determining control output 178 during CPM control.

Moving to step 350 in FIG. 3, step 350 of flowchart 300 comprises sensing a second load step to a light load condition through feedback provided by the switching regulator. As shown by FIG. 2A, a load step from a heavy load condition to a light load condition occurs just prior to time 3 and corresponds to a significant decrease in the current provided as inductor current 220 and load current 224. Referring to FIG. 2C, the load step just prior to time 3 also corresponds to an increase in the output voltage 204. That increase, due to the load step, causes output voltage 204 to rise above the upper threshold of the hysteresis window set by hysteretic comparator 130a (e.g., Vₒᵤₜ>V_{ref+h}).

The rise in the output voltage at node 104 can be sensed, in step 350, using hysteretic comparator 130a of the voltage control path, which compares the output voltage at node 104 to a reference voltage (e.g., once again V_{ref} in FIG. 2C) provided by voltage reference source 152, and turns ON to provide output 132a when Vₒᵤₜ rises above the hysteresis window. That output 132a from hysteretic comparator 130a of the voltage control path is fed back to driver 180 as control signal 178 from digital block 176, as shown in FIG. 1.

As a result, and as indicated by step 360 of flowchart 300, the variable mode switching regulator of voltage converter 100 adjusts the output voltage at node 104 using the variable frequency hysteretic mode during the second load step. Step 360 is also illustrated by FIGS. 2A, 2B, and 2C. Referring to FIG. 2A during the second load step time interval (e.g., interval between dashed vertical lines 203 and 204), inductor current 220 is reduced. Comparing FIGS. 2B and 2C, it can be seen that hysteretic comparator 130a turns ON and remains ON while output voltage 204 is greater than V_{ref+h}. Referring to FIG. 1, in addition to providing output 132a to logic block 176, hysteretic comparator 130a also provides output 132a as a control signal to current source 136a. Consequently, while hysteretic comparator 130a is ON, output 132a activates current source 136a, causing capacitors 156 and 158 to be discharged, thereby causing the error voltage at error node 159 to fall steadily, as shown by FIG. 2B.

As the error voltage at error node 159 is decreased after time 3, the pulse width of output 174 from SR flip-flop 170 is also slowly reduced, corresponding to the transition from fixed frequency CPM control to variable frequency hysteretic mode control in voltage converter 100. Thus, according to embodiments of the present invention, transition between fixed frequency operation advantageous for heavy load conditions, and variable frequency operation advantageous for load step response and light load efficiency can occur automatically in response to load conditions, and can occur substantially without delay.

Steps 310 through 360 may be repeated as necessary to maintain switching efficiency under substantially all load conditions. As may be apparent from the foregoing, various embodiments of the present invention provide numerous advantages over conventionally configured voltage converters. For example, by implementing a fixed frequency control mode during heavy load conditions, embodiments of the present invention ensure efficient operation and good load and line regulation under those load demands. In addition, by enabling transition to a variable frequency control mode when light load conditions or a load step are sensed, embodiments of the present invention concurrently provide improved load step response and enhanced light load efficiency.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

1. A voltage converter comprising:
a switching regulator, a driver, and a power stage receiving an input voltage and producing a converted output voltage;
said switching regulator utilizing a voltage control path and a current control path to provide feedback to said driver corresponding to a load condition of a load in said power stage;
said driver adjusting said converted output voltage in response to said feedback from said switching regulator.

2. The voltage converter of claim 1, wherein said switching regulator utilizes said voltage control path and said current control path to transition control of said voltage converter between a fixed frequency mode control and a variable frequency mode control.

3. The voltage converter of claim 2, wherein said switching regulator is configured to implement said fixed frequency mode control using a current-programmed mode (CPM) for controlling said driver.

4. The voltage converter of claim 2, wherein said switching regulator is configured to implement said variable frequency mode control using a hysteretic mode for controlling said driver.

5. The voltage converter of claim 1, wherein said switching regulator utilizes said voltage control path and said current control path to implement a CPM control of said driver when said load is a heavy load.

6. The voltage converter of claim 1, wherein said switching regulator utilizes said voltage control path and said current control path to implement a hysteretic mode control of said driver when said load is a light load.

7. The voltage converter of claim 1, wherein said switching regulator utilizes said voltage control path and said current control path to implement a hysteretic mode control of said driver when said load condition corresponds to a load step between a light load and a heavy load.

8. The voltage converter of claim 1, wherein said voltage control path utilized by said switching regulator comprises first and second hysteretic comparators for providing a hysteretic mode control of said driver.

9. The voltage converter of claim 1, wherein said switching regulator comprises a logic block receiving first and second inputs from respective first and second hysteretic comparators, said logic block configured to alternately enable a hysteretic mode control and a CPM control of said driver.

10. The voltage converter of claim 1, wherein said current control path comprises a transconductance amplifier, and said voltage control path comprises first and second hysteretic comparators.

11. A method for controlling a voltage converter including a switching regulator, a driver, and a power stage receiving an input voltage and producing a converted output voltage, said method comprising:
driving, by said driver, said power stage of said voltage converter;
utilizing a voltage control path and a current control path by said switching regulator to provide feedback to said driver corresponding to a load condition of a load in said power stage;
adjusting said converted output voltage in response to said feedback from said switching regulator.

12. The method of claim 11, further comprising transitioning control of said voltage converter between a fixed frequency mode control and a variable frequency mode control according to said feedback.

13. The method of claim 12, further comprising implementing said fixed frequency mode control using a current-programmed mode (CPM) control for controlling said driver.

14. The method of claim 12, further comprising implementing said variable frequency mode control using a hysteretic mode control for controlling said driver.

15. The method of claim 11, further comprising utilizing said voltage control path and said current control path to implement a CPM control of said driver when said load is a heavy load.

16. The method of claim 11, further comprising utilizing said voltage control path and said current control path to implement a hysteretic mode control of said driver when said load is a light load.

17. The method of claim 11, further comprising utilizing said voltage control path and said current control path to implement a hysteretic mode control of said driver when said load condition corresponds to a load step between a light load and a heavy load.

18. The method of claim 11, wherein said voltage control path utilized by said switching regulator comprises first and second hysteretic comparators for providing a hysteretic mode control of said driver.

19. The method of claim 11, wherein said switching regulator comprises a logic block receiving first and second inputs from respective first and second hysteretic comparators, said logic block configured to alternately enable a hysteretic mode control and a CPM control of said driver.

20. The method of claim 11, wherein said current control path comprises a transconductance amplifier, and said voltage control path comprises first and second hysteretic comparators.
